(19) United States
(12) Patent Application Publication
(10) Pub. No.: US 2010/0173603 A1
(43) Pub. Date: Jul. 8, 2010

(54) METHOD AND SYSTEM FOR TRANSMITTING AND RECEIVING WARNING MESSAGE

(75) Inventors: Dong Yong Kwak, Daejeon (KR); Hyun Seo Oh, Daejeon (KR); Wan Sik Choi, Daejeon (KR); Jong-Hyun Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/617,130

(22) Filed: Nov. 12, 2009

Related U.S. Application Data
(60) Provisional application No. 61/142,734, filed on Jan. 6, 2009.

(51) Int. Cl. H04M 11/04

(52) U.S. Cl. 455/404.1

(57) ABSTRACT

Provided are a method and a system for transmitting and receiving a warning message that rapidly inform an adjacent hop of a dangerous situation that occurs on a road. The method for transmitting the warning message includes selecting one or more relay vehicles by using distances between vehicles and state information of the vehicles when the dangerous situation occurs on a road or outside, and increasing a warning message sequence number and generating and transmitting a warning message containing an identifier of the relay vehicle and a retransmission time.

### CROSS-REFERENCE TO RELATED APPLICATION

This application claims priority to and the benefit of U.S. Patent Application No. 61/142,734 filed in the United State Patent and Trademark Office on Jan. 6, 2009, the entire contents of which are incorporated herein by reference.

### BACKGROUND OF THE INVENTION

(a) Field of the Invention

The present invention relates to a method and a system for transmitting and receiving a warning message, and more particularly, to a method and a system for transmitting and receiving a warning message that rapidly inform an adjacent hop of a dangerous situation that occurs on a road.

(b) Description of the Related Art

In general, when a dangerous situation occurs on the road, in order to inform of the corresponding dangerous situation through a warning message, there is selected a method of broadcasting the warning message by selecting a vehicle positioned on a radio wave transmission distance boundary when the corresponding dangerous situation occurs without maintaining information on a relay vehicle that will transmit the corresponding warning message.

Since the warning message broadcasting method consumes much time in selecting the relay vehicle that will transmit the warning message in spite of reducing complexity in network administration, the warning message broadcasting method is not suitable for the method for transmitting and receiving the warning message that requires rapidity, and in addition, the warning message broadcasting method cannot be used when an accident occurs in a tunnel.

In addition, another warning message broadcasting method is a method of selecting the relay vehicle through competition between vehicles positioned before a threshold value by allowing all vehicles to maintain positional information on all adjacent vehicles within a radio wave transmission distance and determining a predetermined position in a radio wave radius as the threshold value when an accident occurs.

The warning message transmitting and receiving method through competition between the vehicles sets a retransmission time in inverse proportion to a distance between a transmitter that transmits the warning message and a receiver that receives the warning message.

Therefore, a vehicle that is farthest away from the transmitter within the threshold value has a chance to relay retransmission most rapidly. Further, since vehicles that are positioned in the same boundary distance may transmit the warning message at the same time, message collisions may occur, and as a result, a delay phenomenon frequently occurs at the time of transmitting the warning message.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for transmitting and receiving a warning message having advantages of rapidly informing an adjacent hop of a dangerous situation that occurs on a road.

The present invention has also been made in an effort to provide a system and a method for transmitting and receiving a warning message having advantages of reducing vehicle collision accidents by rapidly and accurately transmitting the warning message because a vehicle that discovers a dangerous situation transmits the warning message to latter vehicles by using multi-hop communication between vehicles when the dangerous situation occurs, such that the system for transmitting and receiving the warning message can be used in a tunnel and can prevent warning messages from colliding with each other between relay vehicles.

In order to achieve the above-mentioned object, according to an exemplary embodiment of the present invention, a warning message can be rapidly transmitted when a dangerous situation occurs on a road by selecting a plurality of relay vehicles on a vehicle network. At this time, in the exemplary embodiment of the present invention, a warning message is transmitted to the adjacent hop with high rapidity and reliability by previously selecting a plurality of vehicles as the relay vehicle.

In other words, according to the exemplary embodiment of the present invention, transmission delay can be solved by selecting one or more relay vehicles on the road, retransmission collisions of the warning message between the corresponding selected relay vehicles can be prevented, and casualties due to a collision accident can be reduced by allowing the vehicle selected as the relay vehicle to rapidly transmit the warning message to the adjacent hop. Herein, according to the exemplary embodiment of the present invention, since the relay vehicles are selected and managed before the collision accident occurs, the warning message can be rapidly transmitted to the adjacent hop by using information of the relay vehicles managed at the time when the accident occurs.

An exemplary embodiment of the present invention provides a method for transmitting a warning message that includes selecting one or more relay vehicles by using distances between vehicles and state information of the vehicles when the dangerous situation occurs on a road or outside, and increasing a warning message sequence number and generating and transmitting a warning message containing an identifier of the relay vehicle and a retransmission time.

Herein, the warning message order number is increased whenever he warning message is transmitted in order to prevent the warning message from being overlapped.

In addition, the method for transmitting the warning message further includes previously setting the number of relay vehicles transmitting the warning message to an adjacent hop to one or more before a dangerous situation occurs, and selecting the set relay vehicle as the relay vehicle when the dangerous situation occurs.

Further, the method for transmitting the warning message includes: a subject vehicle receiving its own positional information from a positioning sensor; receiving positional information from an adjacent vehicle; calculating distances from adjacent vehicles on the basis of positional information of the subject vehicle and the positional information of the adjacent vehicle; classifying adjacent vehicles depending on a direction; and managing a table for sequencing the distances from the adjacent vehicles depending on the direction. At this time, in managing the table, a sequence table in the same direction in which the adjacent vehicles are sequentially arranged is maintained and managed on the basis of the distances from the adjacent vehicles and state information of the vehicles in the same direction as the subject vehicle. Further, in the relay vehicle, one or more latter vehicles are selected as the relay vehicle by using the sequence table. Further, in selecting the relay vehicle, one or more former vehicles are selected as the relay vehicle by using the sequence table.

Herein, the warning message includes information on an identifier of the subject vehicle, a movement direction of a vehicle transmitting the warning message, a sequence number of the warning message, a message type, an identifier of the relay vehicle, and a retransmission time.

Another embodiment of the present invention provides a method for receiving a warning message when a dangerous situation occurs on a road or outside, that includes: receiving the warning message from an adjacent vehicle; verifying whether or not the same warning message is repeatedly received by checking a message sequence number involved in the warning message; verifying whether or not the subject vehicle is a relay vehicle by checking an identifier of the relay vehicle involved in the warning message when the same warning message is not repeatedly received; setting a warning message retransmission timer when the subject vehicle is the relay vehicle; and rebroadcasting the warning message to an adjacent hop when the warning message retransmission timer is timed out.

In addition, the method for receiving the warning message further includes ignoring the warning message when the subject vehicle is not the relay vehicle.

Further, the method for receiving the warning message further includes verifying whether or not the subject vehicle is the relay vehicle by checking an identifier of the relay vehicle involved in the warning message when the same warning message is repeatedly received, and deleting the warning message retransmission timer when the subject own vehicle is the relay vehicle.

In addition, the method for receiving the warning message further includes standing by until the warning message is retransmitted to an adjacent hop on the basis of a retransmission time involved in the warning message when the subject vehicle is the relay vehicle.

Yet another embodiment of the present invention provides a system for transmitting and receiving a warning message when a dangerous situation occurs on a road or outside that includes a vehicle position receiving unit receiving its own vehicle position information from a positioning sensor; a dangerous situation detecting unit generating a dangerous situation notification signal when a dangerous situation occurs; an inter-vehicle distance calculating unit calculating distances from adjacent vehicles on the basis of the positional information received from the vehicle position receiving unit and positional information from the adjacent vehicles; a relay vehicle selecting unit selecting a vehicle for relaying the warning message by receiving the dangerous situation notification signal from the dangerous situation detecting unit; a storage device storing an identifier of the relay vehicle; a vehicle sequence managing unit sequentially arranging vehicles depending on the distances from the adjacent vehicles, which are calculated by the inter-vehicle distance calculating unit and the state of the vehicles; and a communication device receiving the positional information from the adjacent vehicles and generating and transmitting a warning message containing the identifier of the relay vehicle selected by the relay vehicle selecting unit and the retransmission time.

Herein, the storage device stores the distances from the adjacent vehicles that are calculated by the inter-vehicle distance calculating unit, the vehicle sequence arranged by the vehicle sequence managing unit, the identifiers of the adjacent vehicles, and the states of the adjacent vehicles.

In addition, the relay vehicle selecting unit selects the relay vehicle by using the distances from the adjacent vehicles, which are calculated by the inter-vehicle distance calculating unit, and the state information of the adjacent vehicles.

The communication device transmits its own vehicle position information received by the vehicle position receiving unit to the adjacent vehicles and applies the positional information received from the adjacent vehicles to the inter-vehicle distance calculating unit, generates the warning message containing the relay vehicle identifier selected in the relay vehicle selecting unit and the retransmission time, transmits the warning message to the adjacent vehicles, verifies whether or not its own vehicle is the relay vehicle by receiving the warning message from the adjacent vehicles and retransmits the warning message to an adjacent hop on the basis of the warning message retransmission start time for each vehicle that is involved in the corresponding received warning message by actuating the retransmission start timer, and deletes the retransmission start timer and retransmits no warning message at the time of receiving the retransmitted warning message from another relay vehicle.

### BRIEF DESCRIPTION OF THE DRAWINGS

FIG. 1 is a conceptual diagram of an entire system for transmitting and receiving a warning message according to an exemplary embodiment of the present invention.

FIG. 2 is a configuration block diagram illustrating a system for transmitting and receiving a warning message according to an exemplary embodiment of the present invention.

FIG. 3 is a diagram illustrating a format of a warning message according to an exemplary embodiment of the present invention.

FIG. 4 is a diagram illustrating an adjacent vehicle information database provided in a storage device according to an exemplary embodiment of the present invention.

FIG. 5 is a flowchart illustrating a method for transmitting a warning message according to an exemplary embodiment of the present invention.

FIG. 6 is a flowchart illustrating a method for receiving a warning message according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a method and a system for transmitting and receiving a warning message according to an exemplary embodiment of the present invention will be described in detail with reference to the accompanying drawings.

According to an exemplary embodiment of the present invention, a system for transmitting and receiving a warning message, when rapidly transmitting information on a dangerous situation that occurs on a road to an adjacent hop, previously sets a number of relay vehicles transmitting the warning message to an adjacent hop to one or more before the dangerous situation occurs on the road, calculates distances from adjacent vehicles on the basis of its own positional information and positional information of adjacent vehicles, classifies the adjacent vehicles depending on a direction, and maintains a sequence table in the same direction in which the adjacent vehicles are sequentially arranged on the basis of the distances between a subject vehicle and the adjacent vehicles in the same direction and state information of the vehicles.

According to the exemplary embodiment of the present invention, the system for transmitting and receiving the warning message, when the dangerous situation occurs on the road, selects one or more latter relay vehicles by using the sequence table in the same direction, which is maintained by a vehicle that discovers the dangerous situation, notifies that the dangerous situation occurs in the front to the latter vehicles by broadcasting an identifier of the relay vehicle and a retransmission time involved in the warning message, allows the vehicle selected as the relay vehicle to rapidly transmit the warning message to an adjacent hop, and allows the remaining relay vehicles that verify that another vehicle has already transmitted the warning message to surrender their own relay authority to prevent retransmission collisions between the relay vehicles. As a result, transmission delay of the warning message can be solved when the dangerous situation occurs on the road.

In other words, all the vehicles receive their own vehicle position information from a positioning sensor and transmit their own position information through broadcasting before the dangerous situation occurs on the road. Therefore, the vehicles maintain and manage a table sequencing the distances from adjacent vehicles.

Thereafter, a vehicle that discovers an accident transmits the warning message containing the ID of the relay vehicle and the retransmission start time to the latter vehicles. Therefore, the vehicle that receives the warning message verifies whether or not an ID of its own vehicle is involved in the warning message.

At this time, vehicles of which IDs correspond to the vehicle IDs involved in the warning message stand by until the warning message is retransmitted to the adjacent hop on the basis of a retransmission start time of the warning message for each vehicle, which is involved in the warning message. In addition, a vehicle having a more rapid retransmission time broadcasts the warning message to the adjacent hop.

Therefore, the vehicle that receives the retransmitted warning message deletes its own retransmission start timer and does not retransmit a warning message.

As described above, according to an exemplary embodiment of the present invention, since one or more relay vehicles are previously set before an accident occurs and the relay vehicles are managed, the relay vehicles are selected as the relay vehicles by using information on the relay vehicles managed when the accident occurs, thereby rapidly transmitting the warning message to an adjacent hop. Further, according to the exemplary embodiment of the present invention, the warning message is retransmitted on the basis of a warning message retransmission start time for each relay vehicle, such that transmission delay of the warning message is solved by preventing retransmission collisions of the warning message between the relay vehicles, and as a result, casualties due to the collision accident can be reduced by allowing the vehicle selected as the relay vehicle to rapidly transmit the warning message to the adjacent hop.

On the contrary, according to the exemplary embodiment of the present invention, the system for transmitting and receiving the warning message, when emergency vehicles or fire vehicles are advancing, selects one or more former relay vehicles by using the sequence table in the same direction maintained by its own vehicle, notifies that the emergency vehicle is present a to former vehicle by broadcasting an identifier of the relay vehicle and a retransmission time involved in the warning message, allows the vehicle selected as the relay vehicle to rapidly transmit the warning message to an adjacent hop, and allows the remaining relay vehicles that verify that another vehicle has already transmitted the warning message to surrender its own relay authority to prevent retransmission collisions between the relay vehicles, thereby solving the transmission delay of the warning message.

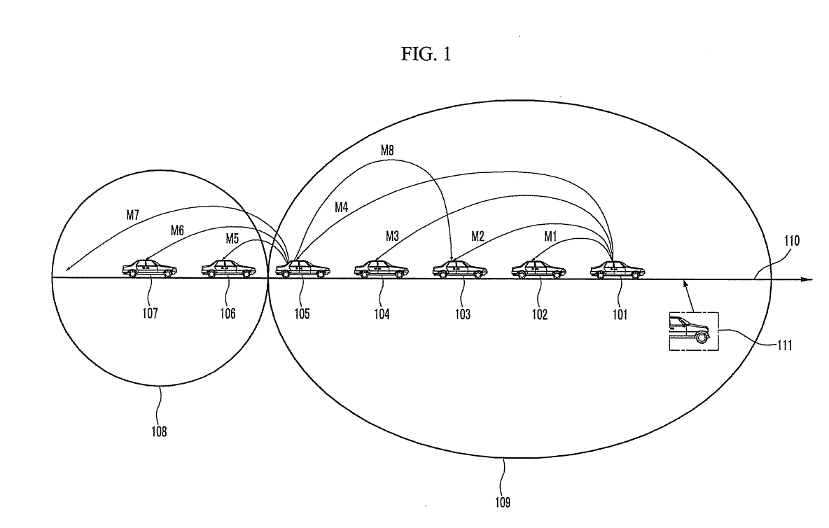

FIG. 1 is a conceptual diagram of an entire system for transmitting and receiving a warning message according to an exemplary embodiment of the present invention.

Herein, for better understanding and ease of description, in FIG. 1, an example in which two vehicles, i.e., a third vehicle 103 and a fifth vehicle 105, are selected as relay vehicles, and the fifth relay vehicle 105 positioned at the last location has a retransmission start time to start earlier than the third relay vehicle 103 positioned at the middle location, will be described in more detail. Further, in FIG. 1, two radio wave regions 108 and 109 and an example in which a first vehicle 101 positioned at the first location transmits the warning message to adjacent vehicles through broadcasting is shown.

First, all vehicles 101 to 107 receive their own positional information from a positioning sensor. In addition, before a dangerous situation occurs on a road 110, all the vehicles 101 to 107 transmit their positioning information to the adjacent vehicles through the broadcasting. Therefore, the vehicles 101 to 107 maintain and manage a table sequencing distances from adjacent vehicles for each direction.

Thereafter, when the dangerous situation occurs on the road 110, the first vehicle 101 that firstly discovers a vehicle 111 that is subjected to an accident transmits warning messages M1 to M4 including a relay vehicle ID and a retransmission start time to latter vehicles 102 to 105 through the broadcasting.

Therefore, the vehicles that discover the dangerous situation, i.e., the latter vehicles 102 to 105 that receive the warning messages M1 to M4 from the first vehicle 101, respectively check whether or not their vehicle IDs are involved in the warning messages M1 to M4.

At this time, the vehicles 103 and 105 having their own IDs corresponding to the vehicle IDs that are involved in the warning messages M1 to M4 recognize themselves as the relay vehicle and stand by until warning messages M5 to M7 are retransmitted to a radio wave region that is, adjacent hop 108 on the basis of the retransmission start time of the warning message for each vehicle, which is involved in the warning messages M2 and M4, by actuating their own retransmission start timers.

In addition, a relay vehicle having an earlier retransmission time, i.e., the fifth vehicle 105, broadcasts the warning messages M5 to M7 to the adjacent hop 108. At this time, the latter vehicles 106 and 107 that are positioned within the adjacent hop 108 receive warning messages M5 to M7 that are retransmitted from the fifth vehicle 105.

On the contrary, another relay vehicle that receives the retransmitted warning message M8 from the fifth vehicle 105, i.e., the third vehicle 103, deletes its own retransmission start timer and retransmits no warning message.

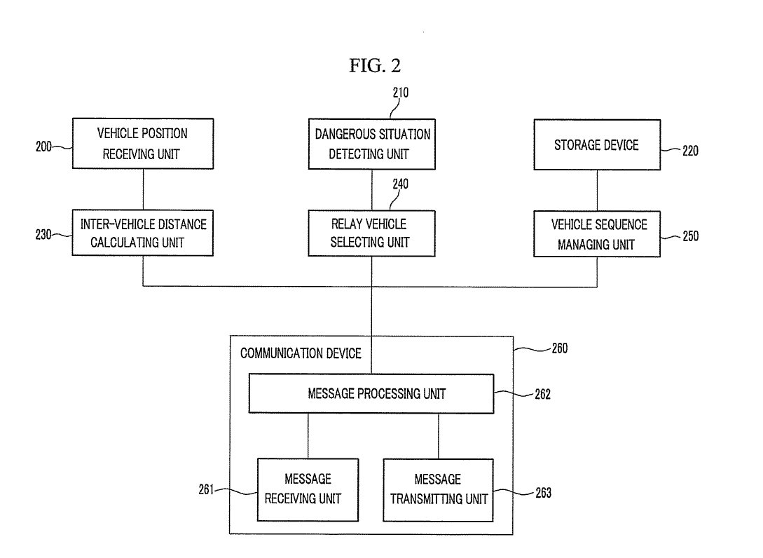

FIG. 2 is a configuration block diagram illustrating a system for transmitting and receiving a warning message according to an exemplary embodiment of the present invention.

The system for transmitting and receiving the warning message according to the exemplary embodiment of the present invention, as a communication system used for a vehicle, includes a vehicle position receiving unit 200, a dangerous situation detecting unit 210, a storage device 220, an inter-vehicle distance calculating unit 230, a relay vehicle selecting unit 240, a vehicle sequence managing unit 250, and a communication device 260, as shown in FIG. 2.

The vehicle position receiving unit 200 receives vehicle position information (i.e., its own positional information) from a positioning sensor and applies the received vehicle position information to the inter-vehicle distance calculating unit 230 and the communication device 260.

The dangerous situation detecting unit 210 discovers the dangerous situation on the road and an external dangerous situation, and generates and applies a dangerous situation notification signal for notifying that the dangerous situation occurs to the relay vehicle selecting unit 240.

The storage device 200 stores an identifier for the relay vehicle selected in the relay vehicle selecting unit 240. Further, the storage device 220 stores distances from adjacent vehicles, which are calculated in the inter-vehicle distance calculating unit 230, stores a table for a vehicle sequence determined in the vehicle sequence managing unit 250, stores an identifier of an adjacent vehicle, which is applied through the communication device 260, and stores the state of the adjacent vehicle, which is applied through the communication device 260.

The inter-vehicle distance calculating unit 230 calculates distances from adjacent vehicles on the basis of its own vehicle position information applied from the vehicle position receiving unit 200 and the positional information received from the adjacent vehicle through the communication device 260, and applies the corresponding calculated distances from the adjacent vehicles to the storage device 220 and the vehicle sequence managing unit 250.

The relay vehicle selecting unit 240 selects a vehicle for relaying the warning message by using distance from the adjacent vehicles and the vehicle state information which are managed by the vehicle sequence managing unit 250 in accordance with the dangerous situation notification signal applied from the dangerous situation detecting unit 210, and applies an identifier of the corresponding selected relay vehicle to the communication device 260. Further, the relay vehicle selecting unit 240 stores information on the identifier of the relay vehicle in the storage device 220.

The vehicle sequence managing unit 250 stores a table for sequentially arranging the vehicles depending on the distances from the adjacent vehicles and the state of the vehicle that are applied from the inter-vehicle distance calculating unit 230 and sequencing distances between adjacent vehicles for each direction in the storage device 220, and maintains and manages the table.

The communication device 260 transmits its own vehicle position information applied from the vehicle position receiving unit 200 to the adjacent vehicles, receives the positional information from the adjacent vehicles, and applies the positional information to the inter-vehicle distance calculating unit 230, generates a warning message containing the relay vehicle identifier selected in the relay vehicle selecting unit 240 and the retransmission start time and transmits the warning message to the adjacent vehicles, verifies whether or not its own vehicle is the relay vehicle by receiving the warning message from the adjacent vehicles and retransmits the warning message to an adjacent hop on the basis of the warning message retransmission start time for each vehicle that is involved in the corresponding received warning message by actuating the retransmission start timer, and deletes the retransmission start timer and retransmits no warning message at the time of receiving the retransmitted warning message from another relay vehicle.

In addition, the communication device 260 includes a message receiving unit 261 receiving a message from an adjacent vehicle, a message processing unit 262 processing the message received through the message receiving unit 261, and a message transmitting unit 263 transmitting the message processed in the message processing unit 262 to the adjacent vehicle.

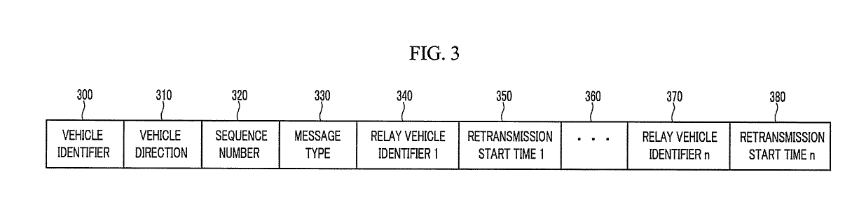

FIG. 3 is a diagram illustrating a format of a warning message according to an exemplary embodiment of the present invention.

Fields constituting the warning message according to the exemplary embodiment of the present invention include a vehicle identifier field 300 indicating an identifier of its own vehicle, a vehicle direction field 310 indicating a movement direction of a vehicle transmitting the message, a message sequence number field 320 that is increased whenever the transmission vehicle transmits the message in order to prevent the warning message from being overlapped, a message type field 330 indicating the type of message, relay vehicle identifier fields 340, 360 and 370 indicating an identifier of a relay vehicle that will transmit the warning message to an adjacent hop, and rebroadcasting start time fields 350, 360, and 380 indicating the retransmission start time for each relay vehicle, as shown in FIG. 3.

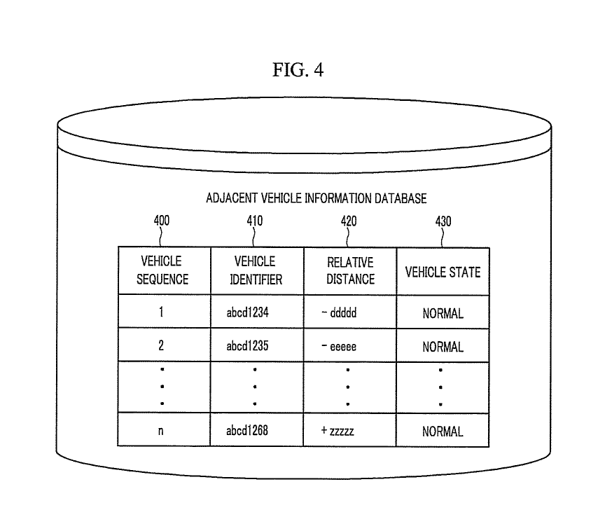

FIG. 4 is a diagram illustrating an adjacent vehicle information database provided in a storage device according to an exemplary embodiment of the present invention.

The adjacent vehicle information database provided in the storage device according to the exemplary embodiment of the present invention includes a vehicle sequence field 400 indicating a vehicle sequence, a vehicle identifier field 410 storing an identifier of an adjacent vehicle, a relative distance field 420 indicating relative distances between its own vehicle and the adjacent vehicle, and a vehicle state field 430 storing the state of the vehicle, as shown in FIG. 4.

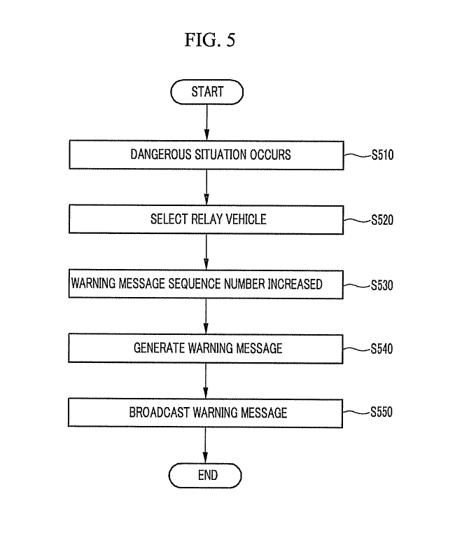

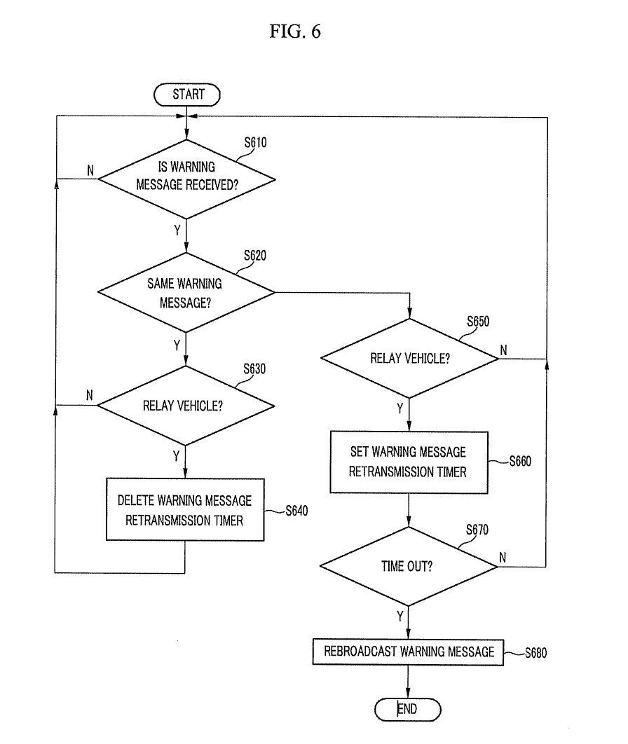

Hereinafter, a method for transmitting and receiving a warning message according to an exemplary embodiment of the present invention will be described in detail with reference to FIGS. 5 and 6.

FIG. 5 is a flowchart illustrating a method for transmitting a warning message according to an exemplary embodiment of the present invention. FIG. 6 is a diagram illustrating a method for receiving a warning message according to an exemplary embodiment of the present invention.

First, in the system for transmitting and receiving the warning message according to the exemplary embodiment of the present invention, a processing flow in regards to a vehicle transmitting the warning message will be described below with reference to FIG. 5.

When a dangerous situation on a road and an external dangerous situation occur, the dangerous situation detecting unit 210 discovers the dangerous situation (S510) and requests the relay vehicle selecting unit 240 to broadcast a warning message by generating and applying a dangerous situation notification signal for notifying that the dangerous situation occurs to the relay vehicle selecting unit 240.

Therefore, the relay vehicle selecting unit 240 is applied with the dangerous situation notification signal from the dangerous situation detecting unit 210 and selects one or more vehicles for relaying the warning message by using distances between vehicles managed by the vehicle sequence managing unit 250 and state information of the vehicles (S520), and the relay vehicle selecting unit 240 applies an identifier of the selected relay vehicle to the communication device 260 and requests a message processing unit 262 in the corresponding communication device 260 to generate the warning message.

As a result, the message processing unit 262 increases a warning message sequence number (S530), generates a warning message containing the identifier of the relay vehicle selected by the relay vehicle selecting unit 240 and a retransmission start time (S540), and broadcasts the corresponding generated warning message through a message transmitting unit 263 in the communication device 260 (S550). Herein, the warning message sequence number is increased when the message processing unit 262 transmits the warning message in order to prevent the warning message from being overlapped.

Second, in the system for transmitting and receiving the warning message according to the exemplary embodiment of the present invention, a processing flow in regards to a vehicle receiving the warning message will be described below with reference to FIG. 6.

A message receiving unit 261 in the communication device 260 receives the warning message from an adjacent vehicle (S610) and verifies whether or not the same warning message is repeatedly received by comparing message sequence number fields involved in the corresponding received warning message (S620).

Therefore, when the message receiving unit 261 determines that the same warning message is repeatedly received in step S620, the message receiving unit 261 verifies whether or not its own vehicle is a relay vehicle by comparing relay vehicle identified fields involved in the received warning message (S630).

As a result, when the message receiving unit 261 determined that its own vehicle is the relay vehicle in step S630, the message receiving unit 261 deletes its own warning message retransmission timer (S640). Further, in step S630, when the message receiving unit 261 determines that its own vehicle is not the relay vehicle, the message receiving unit 261 ignores the received warning message. Herein, the warning message retransmission timer serves to retransmit the warning message when a corresponding counting time is terminated by counting a warning message retransmission start time for each relay vehicle.

On the contrary, when the message receiving unit 261 determines that the some warning message is not repeatedly received in step S620, the message receiving unit 261 verifies whether or not its own vehicle is the relay vehicle by comparing the relay vehicle identifier fields involved in the received warning message (S650).

At this time, when the message receiving unit 261 determines that its own vehicle is the relay vehicle in step S630, the message receiving unit 261 sets its own warning message retransmission timer (S660). Further, in step S630, when the message receiving unit 261 determines that its own vehicle is not the relay vehicle, the message receiving unit 261 ignores the received warning message.

Therefore, the message receiving unit 261 verifies whether or not the warning message retransmission timer set in step S660 is timed out (S670), and when the warning message retransmission timer is timed out, its own vehicle is selected as a vehicle for relaying the warning message, such that the warning message is rebroadcasted to an adjacent node (S680).

As described above, according to an embodiment of the present invention, transmission delay of the warning message is solved when a dangerous situation occurs on a road, such that a vehicle selected as a relay vehicle rapidly transmits the warning message to an adjacent hop, thereby reducing casualties due to a collision accident and being used even when an accident occurs in a tunnel.

As described above, in the exemplary embodiment of the present invention, the case in which the warning message is rebroadcasted by selecting one or more relay vehicles has been described.

However, the exemplary embodiments of the present invention are implemented not only through the apparatus and method, but may be implemented through a program that realizes functions corresponding to constituent members of the exemplary embodiments of the present invention or a recording medium in which the program is recorded. The present invention can be easily implemented by those skilled in the art as described in the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting a warning message when a dangerous situation occurs on a road or outside, comprising:
selecting one or more relay vehicles by using distances between vehicles and state information of the vehicles when the dangerous situation occurs on a road or outside; and
increasing a warning message sequence number and generating and transmitting a warning message containing an identifier of the relay vehicle and a retransmission time.

2. The method of claim 1, wherein
the warning message sequence number is increased whenever the warning message is transmitted in order to prevent the warning message from being overlapped.

3. The method of claim 1, further comprising:
previously setting the number of relay vehicles transmitting the warning message to an adjacent hop to one or more before the dangerous situation occurs; and
selecting the set relay vehicle as the relay vehicle when the dangerous situation occurs.

4. The method of claim 1, further comprising:
a subject vehicle receiving its own positional information from a positioning sensor;
receiving positional information from an adjacent vehicle;
calculating distances from adjacent vehicles on the basis of positional information of the subject vehicle and the positional information of the adjacent vehicle;
classifying the adjacent vehicles depending on a direction; and
managing a table for sequencing the distances from the adjacent vehicles depending on the direction.

5. The method of claim 4, wherein,
in managing the table,
a sequence table in the same direction in which the adjacent vehicles are sequentially arranged is maintained and managed on the basis of the distances from the adjacent vehicles and state information of the vehicles in the same direction as the subject vehicle.

6. The method of claim 5, wherein,
in selecting the relay vehicle,
one or more latter vehicles are selected as the relay vehicle by using the sequence table.

7. The method of claim 5, wherein. in selecting the relay vehicle,
one or more former vehicles are selected as the relay vehicle by using the sequence table.

8. The method of claim 1, wherein
the warning message includes
information on an identifier of a subject vehicle, a movement direction of a vehicle transmitting the warning message, a sequence number of the warning message, a message type, an identifier of the relay vehicle, and a retransmission time.

9. A method for receiving a warning message when a dangerous situation occurs on a road or outside, comprising:
receiving the warning message from an adjacent vehicle;
verifying whether or not the same warning message is repeatedly received by checking a message sequence number involved in the warning message;
verifying whether or not a subject vehicle is a relay vehicle by checking an identifier of the relay vehicle involved in the warning message when the same warning message is not repeatedly received;
setting a warning message retransmission timer when the subject vehicle is the relay vehicle; and
rebroadcasting the warning message to an adjacent hop when the warning message retransmission timer is timed out.

10. The method of claim 9, further comprising
ignoring the warning message when the subject vehicle is not the relay vehicle.

11. The method of claim 9, further comprising:
verifying whether or not the subject vehicle is the relay vehicle by checking an identifier of the relay vehicle involved in the warning message when the same warning message is repeatedly received; and
deleting the warning message retransmission timer when the subject vehicle is the relay vehicle.

12. The method of claim 9, further comprising
standing by until the warning message is retransmitted to an adjacent hop on the basis of a retransmission time involved in the warning message when the subject vehicle is the relay vehicle.

13. A system for transmitting and receiving a warning message when a dangerous situation occurs on a road or outside, comprising:
a vehicle position receiving unit receiving its own vehicle position information from a positioning sensor;
a dangerous situation detecting unit generating a dangerous situation notification signal when the dangerous situation occurs;
an inter-vehicle distance calculating unit calculating distances from adjacent vehicles on the basis of the positional information received from the vehicle position receiving unit and positional information from the adjacent vehicles;
a relay vehicle selecting unit selecting a vehicle for relaying the warning message by receiving the dangerous situation notification signal from the dangerous situation detecting unit;
a storage device storing an identifier of the relay vehicle;
a vehicle sequence managing unit sequentially arranging vehicles depending on the distances from the adjacent vehicles, which are calculated by the inter-vehicle distance calculating unit and the state of the vehicles; and
a communication device receiving the positional information from the adjacent vehicles and generating and transmitting a warning message containing the identifier of the relay vehicle selected by the relay vehicle selecting unit and the retransmission time.

14. The system of claim 13, wherein
the storage device stores the distances from the adjacent vehicles that are calculated by the inter-vehicle distance calculating unit, the vehicle sequence arranged by the vehicle sequence managing unit, the identifiers of the adjacent vehicles, and the states of the adjacent vehicles.

15. The system of claim 13, wherein
the relay vehicle selecting unit selects the relay vehicle by using the distances from the adjacent vehicles, which are calculated by the inter-vehicle distance calculating unit, and the state information of the adjacent vehicles.

16. The system of claim 13, wherein:
the communication device transmits its own vehicle position information received by the vehicle position receiving unit to the adjacent vehicles and applies the positional information received from the adjacent vehicles to the inter-vehicle distance calculating unit, generates the warning message containing the relay vehicle identifier selected in the relay vehicle selecting unit and the retransmission time, transmits the warning message to the adjacent vehicles, verifies whether or not its own vehicle is the relay vehicle by receiving the warning message from the adjacent vehicles and retransmits the warning message to an adjacent hop on the basis of the warning message retransmission start time for each vehicle that is involved in the corresponding received warning message by actuating the retransmission start timer, and deletes the retransmission start timer and retransmits no warning message at the time of receiving the retransmitted warning message from another relay vehicle.
